(19) United States
(12) Patent Application Publication
(10) Pub. No.: US 2008/0285674 A1
(43) Pub. Date: Nov. 20, 2008

(54) Diversity receiver

(75) Inventors: Ya-Ti Tseng, Chu Pei City (TW); Wen-Sheng Hou, Chung Li City (TW)

Correspondence Address: BIRCH STEWART KOLASCH & BIRCH, PO BOX 747, FALLS CHURCH, VA, 22040-0747, US

(73) Assignee: SILICON INTEGRATED SYSTEMS CORP.

(21) Appl. No.: 11/476,666

(22) Filed: Jun. 29, 2006

(30) Foreign Application Priority Data
Nov. 1, 2005 (TW) 094138191

(51) Int. Cl. H04L 1/02

(52) U.S. Cl. 375/267

(57) ABSTRACT

A diversity receiver includes N number of Fourier transform circuits, N number of channel state estimators, N number of channel equalizers, N number of soft demappers, N number of noise power estimators, N number of multipliers, a combination/selection unit, and a channel decoder. The noise power estimators and multipliers provided in the diversity receiver generate individual channel weights for each channel, which serve as background noise information for the channel decoder.

### BACKGROUND OF THE INVENTION

(a) Field of the Invention

The invention relates to a diversity receiver, and particularly to a diversity receiver for an orthogonal frequency division multiplexing (OFDM) system.

(b) Description of the Related Art

In a time-variant channel, interference between different sub-carriers and rapid channel fading (frequency-selective fading) may seriously degrade system performance and cause an error floor. Hence, a typical orthogonal frequency division multiplexing (OFDM) system often adopts a diversity reception technique to solve the aforesaid problems. The diversity reception technique is widely used in various applications and particularly for mobile reception. Typically, a diversity receiver includes two antennas and their respective signal processing units for subsequent treatments. The two antennas are separately provided for receiving different versions of the same transmitted signal, and the signal processing units are used to select or combine input signals from different transmission paths.

Referring to FIG. 1, a conventional diversity receiver 10 includes two branches 11 and 12 having similar components, a combination/selection unit 1a, and a Viterbi decoder 1b. The branch 11 includes a Fourier transform circuit 111, a channel state estimator 112, a channel equalizer 113, and a soft demapper 114. Further, the branch 12 includes a Fourier transform circuit 121, a channel state estimator 122, a channel equalizer 123, and a soft demapper 124.

When a transmitter (not shown) transmits a first version input signal I₁ (n,k) regarding an nth symbol and a kₜₕ sub-carrier (n and k are positive integers) to the diversity receiver 10, the Fourier transform circuit 111 of the branch 11 receives the first version input signal I₁(n,k) via an antenna and transforms it into a first frequency-domain signal Y₁(n,k). On the other hand, when the transmitter transmits a second version input signal I₂(n,k) regarding an nh symbol and a kₜₕ sub-carrier to the diversity receiver 10, the Fourier transform circuit 121 of the branch 12 receives the second version input signal I₂(n,k) via an antenna and transforms it into a second frequency-domain signal Y₂(n,k). The fourier transform circuit 111 and the fourier transform circuit 121 separately receive the first version input signal I₁(n,k) and the second version input signal I₂(n,k). Note that the first version input signal I₁(n,k) and the second version input signal I₂(n,k) include the same data but are distinguished as being transmitted via different antenna path or at different time.

The mathematical models for the frequency-domain signals Y₁(n,k) and Y₂(n,k) are given by the following equation:

Y₁(n,k)=H₁(n,k)S₁(n,k)+V₁(n,k)

Y₂(n,k)=H₂(n,k)S₂(n,k)+V₂(n,k) (1.1)

where H₁(n,k) and H₂(n,k) are respective channel frequency responses of the first and second versions of input signals, S₁(n,k) and S₂(n,k) are transmission data transmitted by the transmitter, and V₁(n,k) and V₂(n,k) are Additive White Gaussian Noises (AWGN). The relationship between Additive White Gaussian Noises of different channels is given by:

σ_{V}_{₁}²≠σ_{V}_{₂}²

which indicates the signal variants of the branch 11 are different to that of the branch 12, i.e. the background noises of the branch 11 and that of the branch 12 are different to each other. However, it should be noted the above relationship does not mean the noises V₁(n,k) and V₂(n,k) are completely unrelated.

The channel state estimator 112 fetches the first frequency-domain signal Y₁(n,k) and evaluates the estimate value of the channel frequency response H₁(n,k) according to a reference signal (such as a pilot signal) contained in the first frequency-domain signal Y₁(n,k). Then, the estimate value of the channel frequency response H₁(n,k) is fed to the channel equalizer 113. Similarly, the channel state estimator 122 outputs the estimate value of the channel frequency response H₂(n,k) to the channel equalizer 123. The channel equalizer 113 receives the first frequency-domain signal Y₁(n,k) and generates a multiplied signal M₁(n,k) according to the estimate value of the channel frequency response H₁(n,k). Similarly, in the second branch 12, the channel equalizer 123 generates another multiplied signal M₂(n,k) through the same treatments. The multiplied signals M₁(n,k) and M₂(n,k) are given by:

M₁(n,k)=|H₁(n,k)|²S₁(n,k)+H₁·(n,k)V₁(n,k)

M₂(n,k)=|H₂(n,k)|² S₂(n,k)+H₂·(n,k)V₂(n,k) (1.2)

where H₁·(n,k) and H₂·(n,k) are respective complex conjugates of H₁(n,k) and H₂(n,k).

Next, the multiplied signal M₁(n,k) is divided by |H₁(n,k)|² by means of a divider 113d in the channel equalizer 113 to generate a first equalized signal E_{O1}(n,k). Similarly, a second equalized signal E_{O2}(n,k) is generated by the same division operation performed by a divider 123d in the channel equalizer 123 of the branch 12. Thus, we obtain:

E_{O1}(n,k)=S₁(n,k)+{(H·(n,k)V₁(n,k))/|H₁(n,k)|²}

E_{O2}(n,k)=S₂(n,k)+{(H₂·(n,k)V₂(n,k) )/|H₂(n,k)²} (1.3)

Further, the values of the divisors, namely |H₁(n,k)|² and |H₂(n,k)|² , are fed to the combination/selection unit 1a and serve as reference information for the Viterbi decoder 1b.

Typically, the noise term in Equation 1.3, i.e. {(H₁·(n,k)V₁(n,k))/|H₁(n,k)|² } or {(H₂·(n,k)V₂(n,k )/|H₂(n,k)|² }, is so small as to be neglected compared to the transmission data S₁(n,k) and S₂(n,k). Hence, the first and second equalized signal E_{O1}(n,k) and E_{O2}(n,k) can be rewritten as:

E_{O1}(n,k)=S₁(n,k)

E_{O2}(n,k)=S₂(n,k) (1.4)

Then, the transmission data S₁(n,k) and S₂(n,k) can be extracted after equalization and then respectively transmitted to the soft demappers 114 and 124. The soft demappers 114 and 124 perform symbol demapping on them to respectively generate demapped signals Sf₁(n,k) and Sf₂(n,k) that are fed to the combination/selection unit 1a.

Finally, the combination/selection unit 1a perform either combination or selection on the demapped signals Sf₁(n,k), Sf₂(n,k) and the values of the divisors |H₁(n,k)|², |H₂(n,k)|² according to their response qualities to generate a decode signal E. The decode signal E is transmitted to the Viterbi decoder 1b to generate a decoded data O.

However, in the conventional design, since the channel weights of different branches set by their respective channel equalizers are equal to each other, the Viterbi decoder 1b can be provided with only channel information but without background noise information about each channel. Therefore, the decoding performance of the Viterbi decoder 1b is difficult to be improved.

### BRIEF SUMMARY OF THE INVENTION

Hence, an object of the invention is to provide a diversity receiver for an OFDM system having improved decoding performance where background noise information is provided as reference decoding information for a channel decoder.

According to the invention, a diversity receiver for an OFDM system includes N number of Fourier transform circuits, N number of channel state estimators, N number of channel equalizers, N number of soft demappers, N number of noise power estimators, N number of multipliers, a combination/selection unit, and a channel decoder. The diversity receiver has N number of branches (N is a positive integer) for receiving M number of versions (M is a positive integer) of input signals. A Pₜₕ Fourier transform circuit (P is a positive integer; 1≦P≦N) receives a Qₜₕ version input signal (Q is a positive integer; 1≦Q≦M) and generates a Pₜₕ frequency-domain signal comprising at least a Pₜₕ transmission data. A Pₜₕ channel state estimator generates a Pₜₕ estimate channel frequency response and a Pₜₕ estimate transmission value according to the Pₜₕ frequency-domain signal. A Pₜₕ channel equalizer receives the Pₜₕ frequency-domain signal and generates a Pₜₕ equalized signal and the square of the absolute value of the Pₜₕ estimate channel frequency response according to the Pₜₕ estimate channel frequency response, and the Pₜₕ equalized signal comprises the P_{td} transmission data. A Pₜₕ soft demapper receives the Pₜₕ equalized signal and performs symbol mapping on the Pₜₕ equalized signal to generate a Pₜₕ output signal. A Pₜₕ noise power estimator receives the Pₜₕ frequency-domain signal and generates a Pₜₕ channel weight according to the Pₜₕ estimate transmission value. A Pₜₕ multiplier multiplies the Pₜₕ output signal by the Pₜₕ channel weight to output a Pₜₕ multiplication. The combination/selection unit receives N number of the multiplications and N number of the squares of the absolute values of the estimate channel frequency responses, and then it performs either combination or selection on the multiplications and the squares of the absolute values of the estimate channel frequency responses according to their signal qualities to generate a decode signal. The channel decoder decodes the decode signal to generate decoded data

Through the design of the invention, the noise power estimators and multipliers are provided in the diversity receiver to generate individual channel weights for each channel, which serve as background noise information for the channel decoder for subsequent treatments so as to improve the decoding performance of the channel decoder.

### BRIEF DESCRIPTION OF THE DRAWINGS

FIG. 1 shows a block diagram illustrating a conventional diversity receiver

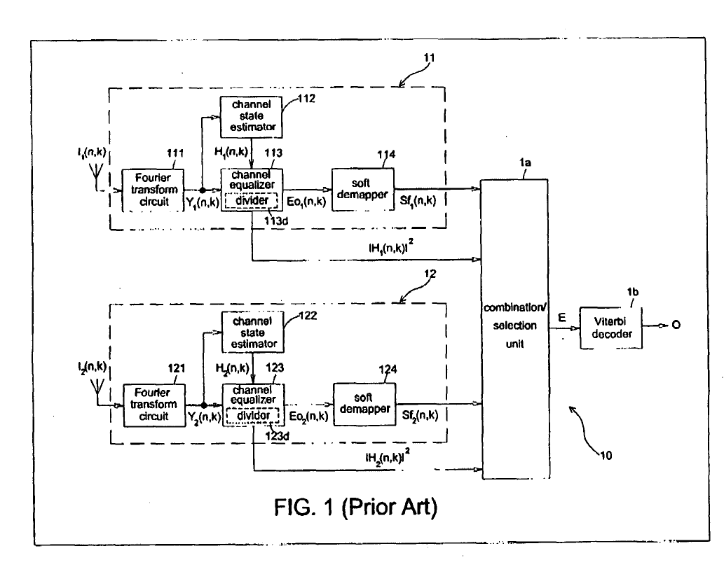

FIG. 2 shows a block diagram illustrating a diversity receiver of the present invention.

### DETAILED DESCRIPTION OF THE INVENTION

Detail descriptions of the diversity receiver for an OFDM system according to the invention will be provided in the following in order to make the invention thoroughly understood. The symbols n, k, N, M, P, Q used in the following descriptions are positive integers.

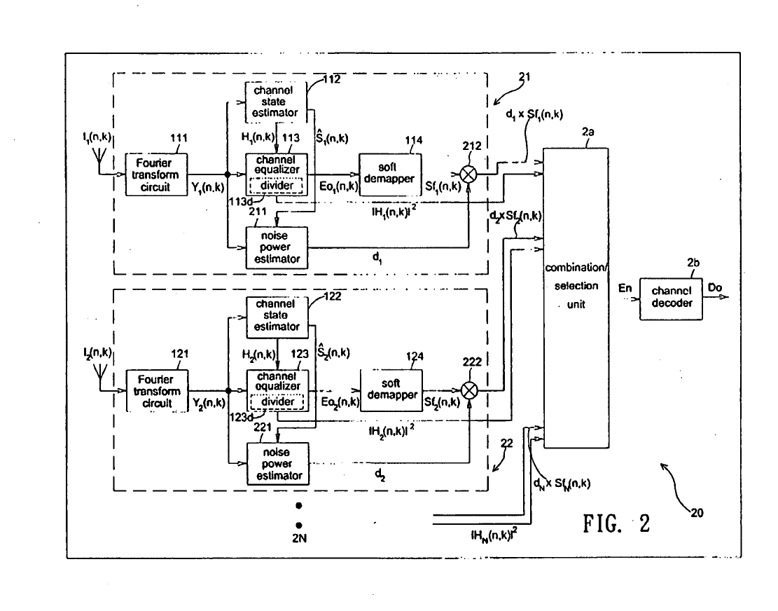

FIG. 2 shows a block diagram illustrating an embodiment of the invention. Referring to FIG. 2, the diversity receiver 20 for an OFDM system has N number of branches 21˜2N for receiving M number of versions of input signals I₁(n,k)−I_{M}(n,k), where I_{Q}(n,k)(1≦Q≦M) represents an Qₜₕ version input signal regarding an nₜₕ symbol and a kₜₕ sub-carrier transmitted from a transmitter. The diversity receiver 20 includes N number of Fourier transform circuits 111˜1N1, N number of channel state estimators 112˜1N2, N number of channel equalizers 113˜1N3, N number of soft demappers 114˜1N4, N number of noise power estimators 211˜2N1, N number of multipliers 212˜2N2, a combination/selection unit 2a, and a channel decoder 2b.

The Fourier transform circuits 111˜1N1 are respectively provided in branches 21˜2N. The Pₜₕ (1≦:P≦N) Fourier transform circuit 1P1 receives the Qₜₕ version input signal I_{Q}(n,k) and generates a Pₜₕ frequency-domain signal Y_{P}(n,k), where the Pₜₕ frequency-domain signal Y_{P}(n,k) at least contains a Pₜₕ transmission data S_{P}(n,k). The channel state estimators 112˜1N2 are respectively provided in branches 21˜2N. The Pₜₕ channel state estimator 1P2 generates a Pₜₕ estimate channel frequency response H_{P}(n,k) of the Pₜₕ channel and a Pₜₕ estimate transmission value Ŝ_{P}(n,k) according to a Pₜₕ channel reference signal (such as a pilot signal) contained in the Pₜₕ frequency-domain signal Y_{P}(n,k). The channel equalizers 113˜1N3 are respectively provided in branches 21˜2N. The Pₜₕ channel equalizer 1P3 receives the Pₜₕ frequency-domain signal Y_{P}(n,k) and, according to the Pₜₕ estimate channel frequency response H_{P}(n,k), generates a Pₜₕ equalized signal E_{OP}(n,k) and the square of the absolute value of the Pₜₕ estimate channel frequency response |H_{P}(n,k)|², where equalized signal E_{OP}(n,k) at least contains the Pₜₕ transmission data S_{P}(n,k). For example, the Pₜₕ equalized signal E_{OP}(n,k) can be written as: E_{OP}(n,k) S_{P}(n,k).

Further, the Pₜₕ channel equalizer 1P3 generates a Pₜₕ multiplied signal M_{P}(n,k) whose value equals the multiplication of the Pₜₕ equalized signal E_{OP}(n,k) and the square of the absolute value of the Pₜₕ estimate channel frequency response |H_{P}(n,k)|², and the Pₜₕ channel equalizer 1P3 includes a divider 1P3d used to divide the value of the Pₜₕ multiplied signal M_{P}(n,k) by a divisor of the absolute value of the Pₜₕ estimate channel frequency response |H_{P}(n,k)|².

The soft demappers 114˜1N4 are respectively provided in branches 21∞2N. The Pₜₕ soft demapper 1P4 receives the Pₜₕ equalized signal E_{OP}(n,k) and performs symbol demapping to generate a Pₜₕ output signal Sf_{P}(n,k). The noise power estimators 211˜2N1 are respectively provided in branches 21˜2N. The Pₜₕ noise power estimator 2P1 receives the Pₜₕ frequency-domain signal Y_{P}(n,k) and generates a Pₜₕ channel weight dp according to the Pₜₕ estimate transmission value Ŝ_{P}(n,k). The multipliers 212˜2N2 are respectively provided in branches 21˜2N. The Pₜₕ multiplier 2P2 multiplies the Pₜₕ output signal Sf_{P}(n,k) by the Pₜₕ channel weight dₚ. The combination/selection unit 2a receives N number of multiplications d₁×Sf₁(n,k)−d_{N}×Sf_{N}(n,k) and N number of the squares of the absolute values of the estimate channel frequency responses |H₁(n,k)|²˜|H_{N}(n,k)|² and performs either combination or selection on these received signals according to their signal qualities to generate a decode signal En. The decode signal En is transmitted to the channel decoder 2b to generate decoded data Do. The channel decoder 2b may be a Viterbi decoder or a Reed-Solomon decoder.

The operations of the diversity receiver 20 are described as the following where the first and the second branches 21 and 22 are taken as examples. Other branches are similar in operation and thus not explaining in detail. Further, the architecture and operation principle of the diversity receiver 20 of the invention is similar to those of the conventional diversity receiver 10, except each branch of the diversity receiver 20 is additionally provided with a noise estimator 2P1 and a multiplier 2P2 so as to provide background noise information for the channel decoder 2b.

Referring to FIG. 2, a first noise power estimators 211 receives a first frequency-domain signal Y₁(n,k) and generates a first channel weight d₁ according to a first estimate transmission value Ŝ₁(n,k). A first multiplier 212 multiplies a first output signal Sf₁(n,k) generated from the soft demapper by the first channel weight d₁, and then the multiplication d₁×Sf₁(n,k) is output by the first branch 21. Similarly, the multiplication d₂×Sf₂(n,k) is output by the second branch 22. The combination/selection unit 2a receives the multiplications d₁×Sf₁(n,k) and d₂×Sf₂(n,k) and the squares of the absolute values of the estimate channel frequency responses |H₁(n,k)|² and |H₂(n,k)|², and then it performs either combination or selection on these received signals according to their signal qualities to generate a decode signal En to be provided for the channel decoder 2b.

For example, if the combination treatment is performed on the output signals d₁×Sf₁(n,k) and d₂×Sf₂(n,k), the mathematical model of the decode signal En can be written:

En=d₁×soft{S₁(n,k)}+d₂×soft{S₂(n,k) } (2.1)

where the first and the second channel weights d₁ and d₂ can be obtained:

d₁/d₂=E{|\tilde{V}₂ (n,k)|²}/E {|\tilde{V}₁(n,k)|²} (2.2)

E{|\tilde{V}₁(n,k)²}=E{Y₁(n,k)−H₁(n,k)\tilde{S}(n,k)|²}

E{|\tilde{V}₂(n,k)² }=E{Y₂(n,k)−H₂(n,k)\tilde{S}₂(n,k)|²} (2.3)

As shown in Equation 2.2, the first and the second channel weights d₁ and d₂ are in inverse proportion to the mean square deviations of the estimate background noises V₁ and V₂. Also, the estimation equation of the estimate background noises V₁ and V₂ are shown in Equation 2.3. From the Equation 2.2 and Equation 2.3, it is seen the first channel weight d₁ is in inverse proportion to the second channel weight d₂. Certainly, for the condition of more than two branches, the channel weights d₁˜d_{N} can be written as:

d₁×Sf₁(n,k)=d₂×Sf₂(n,k)=. . . =d_{N}×Sf_{N}(n,k); or

{₁:d₂: . . . : d_{N}}={1/E {|V₁(n,k)²}:1/E{|V2(n,k)|²}:. . . :1/E{|V_{N}(n,k)|²}}

Hence, it is seen an Nₜₕ channel weight d_{N} is in inverse proportion to an (N−1)ₜₕ channel weight d_{N-1}. According to the invention, the noise power estimators 211˜2N1 are provided to generate individual channel weights d₁˜d_{N} for each channel, which serve as background noise information for the channel decoder 2b for subsequent treatments so as to improve the decoding performance of the channel decoder 2b.

Further, the diversity receiver of the invention may implement various techniques of diversity reception, such as frequency diversity, antenna spatial diversity, antenna polarization diversity, and antenna pattern diversity.

While the invention has been described by way of example and in terms of the preferred embodiments, it is to be understood that the invention is not limited to the disclosed embodiments. To the contrary, it is intended to cover various modifications and similar arrangements as would be apparent to those skilled in the art. Therefore, the scope of the appended claims should be accorded the broadest interpretation so as to encompass all such modifications and similar arrangements.

What is claimed is:

1. A diversity receiver for an orthogonal frequency division multiplexing (OFDM) system having N number of branches (N is a positive integer) for receiving M number of versions (M is a positive integer) of input signals, comprising:
N number of Fourier transform circuits respectively provided in the N number of branches, wherein a Pₜₕ Fourier transform circuit (P is a positive integer; 1≦P≦N) receives a Qₜₕ version input signal (Q is a positive integer; 1≦Q≦M) and generates a Pₜₕ frequency-domain signal;
N number of channel state estimators respectively provided in the N number of branches, wherein a Pₜₕ channel state estimator generates a Pₜₕ estimate channel frequency response and a Pₜₕ estimate transmission value according to the Pₜₕ frequency-domain signal;
N number of channel equalizers respectively provided in the N number of branches, wherein a Pₜₕ channel equalizer receives the Pₜₕ frequency-domain signal and generates a Pₜₕ equalized signal and the square of the absolute value of the Pₜₕ estimate channel frequency response according to the Pₜₕ estimate channel frequency response;
N number of soft demappers respectively provided in the N number of branches, wherein a Pₜₕ soft demapper receives the Pₜₕ equalized signal and performs symbol mapping on the Pₜₕ equalized signal to generate a Pₜₕ output signal;
N number of noise power estimators respectively provided in the N number of branches, wherein a Pₜₕ noise power estimator receives the Pₜₕ frequency-domain signal and generates a Pₜₕ channel weight according to the Pₜₕ estimate transmission value; and
N number of multipliers respectively provided in the N number of branches, wherein a Pₜₕ multiplier multiplies the Pₜₕ output signal by the Pₜₕ channel weight to output a Pₜₕ multiplication.

2. The diversity receiver as claimed in claim 1, wherein the Pₜₕ frequency-domain signal comprises a Pₜₕ transmission data, and the Pₜₕ equalized signal comprises the Pₜₕ transmission data.

3. The diversity receiver as claimed in claim 1, further comprising a combination/selection unit for receiving N number of the multiplications and the squares of the absolute values of the estimate channel frequency responses, and performing either combination or selection on the multiplications and the squares of the absolute values of the estimate channel frequency responses according to their signal qualities to generate a decode signal.

4. The diversity receiver as claimed in claim 3, further comprising a channel decoder for decoding the decode signal to generate decoded data.

5. The diversity receiver as claimed in claim 4, wherein the channel decoder is a Viterbi decoder or a Reed-Solomon decoder.

6. The diversity receiver as claimed in claim 1, wherein the Pₜₕ channel equalizer generates a Pₜₕ multiplied signal whose value equals the multiplication of the Pₜₕ equalized signal and the square of the absolute value of the Pₜₕ estimate channel frequency response, and the Pₜₕ channel equalizer further comprises a divider used to divide the value of the Pₜₕ multiplied signal by a divisor of the square of the absolute value of the Pₜₕ estimate channel frequency response.

7. The diversity receiver as claimed in claim 2, wherein the Pₜₕ equalized signal is written as
E_{OP}(n,k)=S_{P}(n,k);
where E_{OP}(n,k) is the Pₜₕ equalized signal and S_{P}(n,k) is the Pₜₕ transmission data.

8. The diversity receiver as claimed in claim 1, wherein the Pₜₕ frequency-domain signal comprises a Pₜₕ reference signal, and the Pₜₕ channel state estimator estimates the Pₜₕ estimate transmission value according to the Pₜₕ reference signal.

9. The diversity receiver as claimed in claim 8, wherein the Pₜₕ reference signal is a pilot signal.

10. The diversity receiver as claimed in claim 1, wherein the Pₜₕ channel weight is in inverse proportion to a (P−1)ₜₕ channel weight.

11. A diversity receiver for an orthogonal frequency division multiplexing (OFDM) system for receiving M number of versions (M is a positive integer) of input signals at different time, comprising:
a Fourier transform circuit for receiving a Qₜₕ version input signal (Q is a positive integer; 1≦Q≦M) and generates a Pₜₕ (P is a positive integer; 1≦P≦M)frequency-domain signal;
a channel state estimator for generating a Pₜₕ estimate channel frequency response and a Pₜₕ estimate transmission value according to the Pₜₕ frequency-domain signal;
a channel equalizer for receiving the Pₜₕ frequency-domain signal and generating a Pₜₕ equalized signal and the square of the absolute value of the Pₜₕ estimate channel frequency response according to the Pₜₕ estimate channel frequency response;
a soft demapper for receiving the Pₜₕ equalized signal and performing symbol mapping on the Pₜₕ equalized signal to generate a Pₜₕ output signal;
a noise power estimator for receiving the Pₜₕ frequency-domain signal and generating a Pₜₕ channel weight according to the Pₜₕ estimate transmission value; and
a multiplier for multiplying the Pₜₕ output signal by the Pₜₕ channel weight to output a Pₜₕ multiplication.

12. The diversity receiver as claimed in claim 11, wherein the Pₜₕ frequency-domain signal comprises a Pₜₕ transmission data, and the Pₜₕ equalized signal comprises the Pₜₕ transmission data.

13. The diversity receiver as claimed in claim 11, further comprising a combination/selection unit for receiving M number of the multiplications and the squares of the absolute values of the estimate channel frequency responses, and performing either combination or selection on the multiplications and the squares of the absolute values of the estimate channel frequency responses according to their signal qualities to generate a decode signal.

14. The diversity receiver as claimed in claim 13, further comprising a channel decoder for decoding the decode signal to generate decoded data.

15. The diversity receiver as claimed in claim 14, wherein the channel decoder is a Viterbi decoder or a Reed-Solomon decoder.

16. The diversity receiver as claimed in claim 11, wherein the channel equalizer generates a Pₜₕ multiplied signal whose value equals the multiplication of the Pₜₕ equalized signal and the square of the absolute value of the Pₜₕ estimate channel frequency response, and the channel equalizer further comprises a divider used to divide the value of the Pₜₕ multiplied signal by a divisor of the square of the absolute value of the Pₜₕ estimate channel frequency response.

17. The diversity receiver as claimed in claim 12, wherein the Pₜₕ equalized signal is written as
E_{OP}(n,k)=S_{P}(n,k);
where E_{OP}(n,k) is the Pₜₕ equalized signal and S_{P}(n,k) is the Ph transmission data.

18. The diversity receiver as claimed in claim 11, wherein the Pₜₕ frequency-domain signal comprises a Pₜₕ reference signal, and the channel state estimator estimates the Pₜₕ estimate transmission value according to the Pₜₕ reference signal.

19. The diversity receiver as claimed in claim 18, wherein the Pₜₕ reference signal is a pilot signal.

20. The diversity receiver as claimed in claim 11, wherein the Pₜₕ channel weight is in inverse proportion to a (P−1)ₜₕ channel weight.
